(19) United States
(12) Patent Application Publication
(10) Pub. No.: US 2025/0146243 A1
(43) Pub. Date: May 8, 2025

(54) VESSEL

(71) Applicant: IQIP HOLDING B.V., Sliedrecht (NL)

(72) Inventors: Quintus Wilhelmus Petrus Zuijdgeest, Zoetermeer (NL); André Van Tol, Sliedrecht (NL); Klaas-Jan Mulderij, Hengelo (NL)

(21) Appl. No.: 18/837,051

(22) PCT Filed: Feb. 7, 2023
(86) PCT No.: PCT/NL2023/050051

§ 371 Date: Aug. 8, 2024

(30) Foreign Application Priority Data
Feb. 11, 2022 (NL) 2030893

(51) Int. Cl. E02D 15/08; B63B 35/00

(52) U.S. Cl. CPC E02D 15/08; B63B 35/003

(57) ABSTRACT

A vessel comprises an upending hinge having a frame mounted to at least one of a deck and a hull and a bearing member having a bearing surface between legs for bearing a monopile. The bearing member has bearing member pivots having a common axis of rotation. The bearing member has a monopile receiving position, which is a rotational position with respect to the common axis of rotation in which the bottom of the bearing member is located below the common axis of rotation and the bearing surface is facing upwardly. The bearing member also has a monopile upending position, which is a rotational position with respect to the common axis of rotation of in which the bearing surface is located outside and facing away from a circumferential wall at the location of the upending hinge. The frame is provided with a lifting mechanism for lowering the bearing member pivots.

### CROSS-REFERENCE TO RELATED APPLICATION(S)

This Application is a Section 371 National Stage Application of International Application No. PCT/NL2023/050051, filed Feb. 7, 2023 and published as WO 2023/153922 A1 on Aug. 17, 2023, in English.

### BACKGROUND

The present invention relates to a vessel comprising a hull including a circumferential wall, a deck and an upending hinge which is provided with a frame that is mounted to at least one of the deck and the hull at a position along the circumferential wall and a bearing member including a bottom, two legs located at a distance from each other and extending from the bottom and a bearing surface between the legs for bearing a monopile, which bearing member is mounted to the frame through bearing member pivots at the respective legs having a common axis of rotation at a distance from the bottom of the bearing member and extending in a direction along the circumferential wall at the location of the upending hinge, wherein the bearing member has a monopile receiving position, which is a rotational position with respect to the common axis of rotation of the bearing member pivots in which the bottom of the bearing member is located below the common axis of rotation of the bearing member pivots and the bearing surface is facing upwardly, and a monopile upending position, which is a rotational position with respect to the common axis of rotation of the bearing member pivots in which the bearing surface is located outside the circumferential wall and facing away from the circumferential wall at the location of the upending hinge.

Such a vessel is known in the prior art. The known vessel is used for installing monopiles in a seabed. The monopiles are transported horizontally by the vessel to an off-shore installation site. At the installation site a monopile to be installed in the seabed is lifted by a lifting carriage and displaced to an upending line of the upending hinge where it is lowered and positioned on the bearing surface thereof. Subsequently, a crane lifts the monopile at a distance from the bearing member pivots such that it is upended by means of the crane, assisted with the upending hinge. In the monopile upending position the bearing surface is located outside the circumferential wall such that the monopile can extend upright outside the circumferential wall of the hull at the location of the upending hinge. After the step of upending the monopile it is moved by the crane to a gripper, where it is placed onto the seabed. Then, a pile driving device is placed on top of the monopile which drives the monopile into the seabed. A disadvantage of the known vessel is that lifting the monopile before positioning it on the bearing surface of the bearing member may lead to an unstable condition.

### SUMMARY

A vessel facilitates the process of positioning a monopile on the bearing surface of the bearing member, wherein the frame is provided with a lifting mechanism for lowering the bearing member pivots with respect to their positions in the monopile receiving position of the bearing member.

When the bearing member pivots are at a lower height level than in the monopile receiving position of the bearing member the monopile may be lifted with respect to the deck by a lifting carriage to only a relatively low height level in order to move the monopile over one of the bearing member pivots so as to position the monopile above the bearing surface at the upending line. This is advantageous in terms of stability of the monopile on the lifting carriage. The lifting carriage may prevent a crane on the vessel from being used to move a monopile from a monopile storage on the deck to the upending line. After the monopile has arrived at the upending line and is positioned above the bearing surface the lifting mechanism of the upending hinge can move the bearing member pivots upwardly such that the monopile can be received between the legs of the bearing member. After the bearing member has achieved its monopile receiving position the monopile may be lowered by the lifting carriage until it rests on the bearing surface.

The common axis of rotation of the bearing member pivots may lie outside the circumferential wall in the monopile receiving position. This provides the opportunity to keep the common axis of rotation of the bearing member at the same location in both the monopile receiving position and the monopile upending position of the bearing member such that the bearing member only rotates between the monopile receiving position and the monopile upending position.

The bearing member be U-shaped.

In a particular embodiment the lifting mechanism comprises a bearing member support which is mounted to the bearing member through the bearing member pivots and which is mounted to one of the deck and the hull through a support pivot having an axis of rotation which is parallel to the axis of rotation of the bearing member pivots, wherein the bearing member support is rotatable about the axis of rotation of the support pivot by means of a driving device. Upon rotating the bearing member support the height level of the common axis of rotation of the bearing member pivots with respect to the deck will vary. The bearing member support may be arranged such that upon rotating it in outward direction from the circumferential wall of the hull at the upending hinge the bearing member moves downwardly next to the circumferential wall such that at least a part thereof can move to a position below the level of the deck.

The bearing member support may be rigid such that a distance between the common axis of rotation of the bearing member pivots and the axis of rotation of the support pivot is fixed.

In an embodiment the lifting mechanism comprises a four-bar linkage, of which the deck forms a first bar, whereas a second bar is mounted to the deck through a second bar pivot having an axis of rotation which is parallel to the axis of rotation of the bearing member pivots, a third bar is mounted to the deck through a third bar pivot having an axis of rotation which is parallel to the axis of rotation of the second bar pivot and a fourth bar is formed by an upper link that is mounted to the second bar through a first upper link pivot having an axis of rotation which is parallel to the axis of rotation of the second bar pivot and to the third bar through a second upper link pivot having an axis of rotation which is parallel to the axis of rotation of the third bar pivot, wherein the bearing member is mounted to at least one of the second bar and the upper link through the bearing member pivots, wherein the second bar is rotatable about the axis of rotation of the second bar pivot by means of a driving device.

The first upper link pivot and the bearing member pivots are adapted such that their axes of rotation coincide. This means that the second bar, the upper link and the bearing member are rotatable with respect to each other about a single axis of rotation.

In an embodiment the third bar is extendable by an actuator such that the distance between the axes of rotation of the third bar pivot and the second upper link pivot is adjustable and the lifting mechanism is provided with an arm which is mounted to at least one of the upper link and the third bar through a first arm pivot, on the one hand, and to the deck through a second arm pivot, on the other hand, which first and second arm pivots have axes of rotation which are parallel to each other and to the axis of rotation of the third bar pivot, wherein the axis of rotation of the third bar pivot lies between the axes of rotation of the second bar pivot and the second arm pivot, wherein the driving device comprises the third bar including the actuator, the upper link, the third bar pivot, the first upper link pivot, the bearing member pivots, the first arm pivot, the second upper link pivot, the arm and the second arm pivot.

The actuator may be a linear actuator such as a hydraulic cylinder. When the actuator varies the distance between the axes of rotation of the third bar pivot and the second upper link pivot, the arm will be rotated and consequently the upper link will rotate the second bar. This provides the opportunity to configure the frame such that when the actuator reduces the distance between the axes of rotation of the third bar pivot and the second upper link pivot, the arm as well as the third bar as well as the second bar rotate in a direction away from the circumferential wall at the location of the upending hinge. In this case the upending hinge can be changed to a folded condition in which the bearing member pivots and the second upper link pivot lie at a lower level than when the bearing member is in the monopile receiving position.

The first arm pivot and the second upper link pivot may be adapted such that their axes of rotation coincide. This means that the third bar, the upper link and the arm are rotatable with respect to each other about a single axis of rotation.

In a preferred embodiment the arm is an articulated arm, comprising two arm sections which are mounted to each other through an intermediate pivot having an axis of rotation which is parallel to the axes of rotation of the first and second arm pivots, wherein the driving device is a first driving device and the frame is further provided with a second driving device for rotating the arm sections with respect to each other. This embodiment provides the opportunity to configure the frame such that when the arm sections are rotated with respect to each other the arm will pull the third bar and the second bar in a direction which is directed from outside the circumferential wall towards the circumferential wall at the location of the upending hinge. Consequently, the bearing member also moves in a direction which is directed from outside the circumferential wall towards the circumferential wall at the location of the upending hinge. This is an advantageous movement after the bearing member has arrived in the monopile upending position, since the bearing surface is retracted from the monopile in the upended orientation which simplifies further handling of the monopile without collisions with the bearing member, i.e. moving it to the gripper. The frame may be configured such that in this condition of the upending hinge, which may be called a retracted condition, a large part of the bearing member is located above the deck within the circumferential wall of the hull. A further advantage of retracting the upending hinge towards the hull is that the crane doesn't need to reach relatively far to move the monopile to the gripper, which minimizes the risk of overloading the crane and allows to handle relatively heavy piles.

In an embodiment the second bar of the four-bar linkage is formed by the bearing member support, the second bar pivot is formed by the support pivot, and the first upper link pivot and the bearing member pivots are adapted such that their axes of rotation coincide.

In a particular embodiment the vessel is provided with a lifting carriage for lifting a horizontally oriented monopile, wherein the lifting carriage comprises a chassis which is drivable in a direction of movement on the deck, an arc-shaped cradle which extends between a first edge and a second edge thereof and which is mounted to the chassis, wherein the cradle is provided with a supporting surface for supporting a horizontally oriented monopile, which supporting surface is configured to lie on an imaginary cylinder having a substantially circular cross-section and a longitudinal centerline extending transversely to the direction of movement in case of supporting a monopile, wherein the cradle is liftable with respect to the chassis and rotatable with respect to the chassis about an axis of rotation which substantially coincides with the centerline between a monopile supporting position and a monopile approaching position, wherein the first edge lies at a lower height level in case of the monopile approaching position than in case of the monopile supporting position, and wherein the second edge lies at a higher height level in case of the monopile approaching position than in case of the monopile supporting position.

This means that when the cradle is in the monopile approaching position it can be moved to a monopile which is stored on the deck and when the supporting surface is at or close to the monopile the cradle can be rotated in circumferential direction about the monopile to the monopile supporting position. Subsequently, the cradle can be lifted with respect to the chassis and transported towards the upending hinge. An advantage of the rotatable cradle is that due to the relatively low first edge in its monopile approaching position it can catch monopiles which are stored at a relatively low height on the deck, whereas storage at relatively low height is preferred for stability of the vessel.

The first edge and the second edge may lie at substantially the same height level in case of the monopile supporting position. In other words, the cradle may be symmetrical with respect to a vertical plane in which the axis of rotation lies.

The angular distance between the first edge and the second edge is preferably smaller than 180° in order to facilitate positioning the cradle about the monopile.

In an embodiment the cradle comprises a cradle frame to which discrete support elements are mounted next to each other in angular direction about the axis of rotation, together providing the supporting surface, wherein the support elements are movable with respect to the cradle frame such that when the support elements engage a monopile to be lifted they will automatically take positions and orientations which fit to the circumference of the monopile.

At least two support elements may be mounted to a rocker which in turn is mounted to the cradle frame and rotatable with respect to the cradle frame about an axis which is parallel to the axis of rotation in order to force the support elements to take positions and orientations which fit to the circumference of the monopile.

It is noted that the lifting carriage including the rotatable cradle is not necessarily in combination with the upending hinge. In other words, the invention is also related to the following items:

Item 1: A lifting carriage for lifting a horizontally oriented monopile, comprising a chassis which is drivable in a direction of movement, an arc shaped cradle which extends between a first edge and a second edge thereof and which is mounted to the chassis, wherein the cradle is provided with a supporting surface for supporting a horizontally oriented monopile, which supporting surface is configured to lie on an imaginary cylinder having a substantially circular cross-section and a longitudinal centerline extending transversely to the direction of movement in case of supporting a monopile, wherein the cradle is liftable with respect to the chassis and rotatable with respect to the chassis about an axis of rotation which substantially coincides with the centerline between a monopile supporting position and a monopile approaching position, wherein the first edge lies at a lower height level in case of the monopile approaching position than in case of the monopile supporting position, and wherein the second edge lies at a higher height level in case of the monopile approaching position than in case of the monopile supporting position.

Item 2: A lifting carriage according to item 1, wherein the first and the second edge lie at substantially the same height level in case of the monopile supporting position

Item 3: A lifting carriage according to item 1 or 2, wherein the angular distance between the first edge and the second edge is smaller than 180°.

Item 4: A lifting carriage according to any one of the items 1-3, wherein the cradle comprises a cradle frame to which discrete support elements are mounted next to each other in angular direction about the axis of rotation, together providing the supporting surface, wherein the support elements are movable with respect to the cradle frame such that when the support elements engage a monopile to be lifted they will automatically take positions and orientations which fit to the circumference of the monopile.

Item 5: A lifting carriage according to item 4, wherein at least two support elements are mounted to a rocker which in turn is mounted to the cradle frame and rotatable with respect to the cradle frame about an axis which is parallel to the axis of rotation.

Item 6: A lifting carriage according to any one of the items 1-5, wherein the cradle is liftable with respect to the chassis by a plurality of actuators, wherein at least one of the actuators is rotatably mounted to the chassis at a side of the cradle where its first edge is located and extends in vertical direction in the monopile supporting position, wherein the actuator is rotatable with respect to the chassis in the monopile approaching position. Since the actuator may obstruct the cradle from approaching a monopile in its monopile approaching position, the actuator may be rotate away from the vertical orientation, for example to a horizontal orientation.

From the above, it will be clear that lowering the bearing member pivots and rotating the cradle about the monopile to the monopile supporting position, a monopile will remain close to the deck and does not need to be elevated too high to overcome obstacles. The relatively low position of the monopile keeps loads relatively controllable.

### BRIEF DESCRIPTION OF THE DRAWINGS

The invention will hereafter be elucidated with reference to the schematic drawings showing embodiments of the invention by way of example.

FIG. 1 is a perspective view of an embodiment of a vessel.

FIGS. 2 and 3 are similar views as FIG. 1, showing different conditions of the vessel.

FIG. 4 is an enlarged view of a part of the vessel as shown in FIG. 1, showing a part of an upending hinge in a monopile receiving condition as depicted in FIG. 1.

FIG. 5 is a similar view as FIG. 4, but showing the upending hinge in a monopile upending condition as depicted in FIG. 3.

FIG. 6 is a similar view as FIG. 4, but showing the upending hinge in a folded condition.

FIG. 7 is a similar view as FIG. 5, but showing the upending hinge in a retracted condition.

FIG. 8 is a perspective view of an embodiment of a lifting carriage.

FIGS. 9-11 are side views of the lifting carriage as shown in FIG. 8, illustrating successive steps of operating the lifting carriage.

FIG. 12 is a similar view as FIG. 8 on a larger scale, illustrating a condition as shown in FIG. 11.

### DETAILED DESCRIPTION OF THE ILLUSTRATIVE EMBODIMENTS

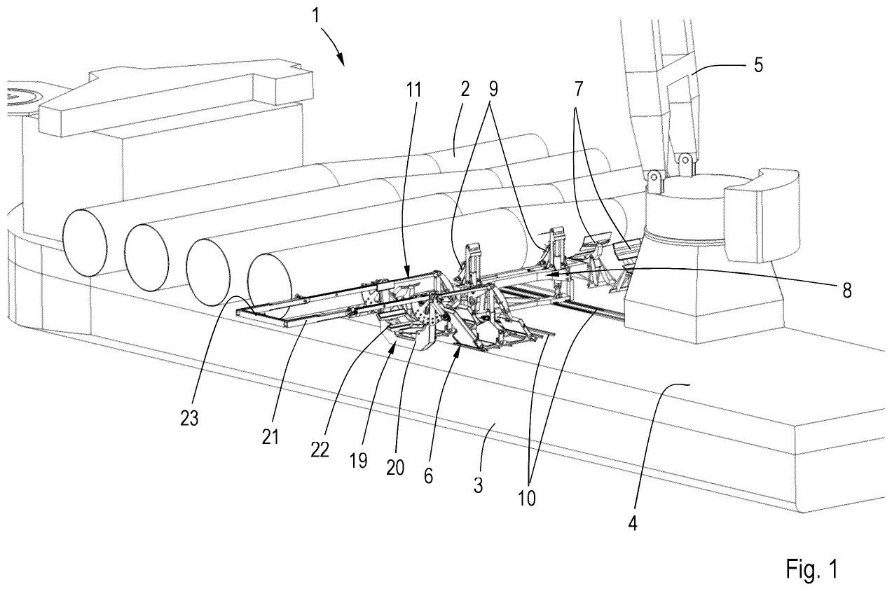

FIG. 1 shows a floating vessel 1 for installing a monopile 2 in a seabed. The vessel 1 has a hull including a circumferential wall 3 and an upper deck 4. A crane 5 for lifting a monopile 2 is mounted on the upper deck 4. The vessel 1 is also provided with a gripper (not shown) for guiding a monopile 2 in its longitudinal direction during driving the monopile 2 into the seabed.

Referring to FIG. 1, under operating conditions, the monopiles 2 are transported horizontally by the vessel 1 from a production facility to an off-shore installation site. At the installation site each of the monopiles 2 is upended by means of the crane 5, assisted with an upending hinge 6.

FIGS. 1-3 illustrate the process of upending a monopile 2. In a first step the monopile 2 is lifted from two fixed monopile cradles 7 by a lifting carriage 8. The fixed monopile cradles 7 are attached to the upper deck 4 at a distance from each other, in this case at opposite locations of the circumferential wall 3 of the hull, i.e. at port and starboard. The lifting carriage 8 is provided with monopile cradles 9 in order to safely support and transport the monopiles 2 to an upending line which extends in transverse direction of the vessel 1 at the upending hinge 6. The lifting carriage 8 is drivable along rails 10 on the upper deck 4. The fixed monopile cradles 7 and the monopile cradles 9 of the lifting carriage 8 have discrete support elements which form an arc, but alternative shapes are conceivable.

Before the lifting carriage 8 including the monopile 2 arrives at the upending line the upending hinge 6 is brought into a folded condition, which will be explained hereinafter. After the lifting carriage 8 including the monopile 2 has arrived at the upending line the upending hinge 6 is changed from the folded condition to a monopile receiving condition and the monopile 2 is lowered such that it rests on the upending hinge 6 and a fixed monopile cradle 7 at the upending line. Subsequently, the crane 5 lifts the monopile 2 at a distance from the upending hinge 6 such that it is upended by means of the crane 5, assisted with the upending hinge 6. After the monopile 2 suspends vertically from a cable of the crane 5 it is moved to the gripper by the crane 5, where the monopile 2 is placed onto the seabed. After that the cable is separated from the monopile 2 and a pile driving device (not shown) is placed on top of the monopile 2 by the crane 5 in order to drive the monopile 2 into the seabed.

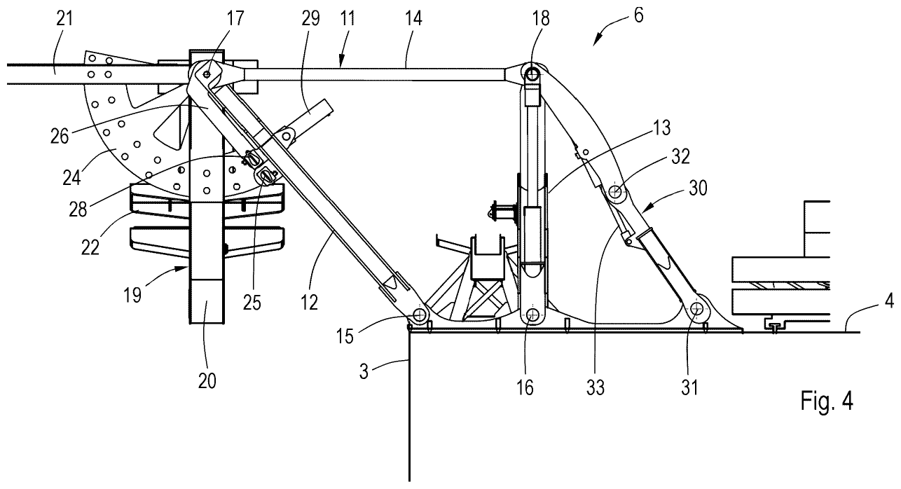

FIG. 4 shows the upending hinge 6 in more detail. It comprises a frame 11 which is mounted to the deck 4 at a position along the circumferential wall 3 of the hull, in this case at port. The frame 11 comprises two identical four-bar linkages which extend parallel to each other within respective vertical planes. A first bar of each of the four-bar linkages is formed by the upper deck 4, a second bar thereof is formed by a support 12, a third bar thereof is formed by an extendable rod 13 and a fourth bar thereof is formed by an upper link 14. The support 12 is mounted to the upper deck 4 through a support pivot 15 which has an axis of rotation which is parallel to the circumferential wall 3 of the hull at port. The extendable rod 13 is mounted to the upper deck 4 through a third bar pivot 16 which has an axis of rotation which is parallel to the axis of rotation of the support pivot 15. The upper link 14 is mounted to the support 12 through a first upper link pivot 17 which has an axis of rotation which is parallel to the axis of rotation of the support pivot 15 and to the extendable rod 13 through a second upper link pivot 18 which has an axis of rotation that is parallel to the axes of rotation of the first upper link pivot 17 and the third bar pivot 16. The extendable rod 13 is provided with a hydraulic cylinder for varying the distance between the axis of rotation of the third bar pivot 16 and the second upper link pivot 18.

The upending hinge 6 is further provided with a bearing member 19 which is mounted to the four-bar linkages through bearing member pivots which have a common axis of rotation that coincides with a common axis of rotation of the first link pivots 17 of the respective four-bar linkages. The bearing member 19 comprises a U-shaped body 20 extending in a first plane and a supporting bracket 21 which extends in a second plane that extends perpendicularly to the first plane. In this case the first and second planes intersect each other along the common axis of rotation of the first link pivots 17, but this may be different in an alternative embodiment. The U-shaped body 20 has a bottom and two parallel legs which are pivotally mounted to the supports 12 and the upper links 14 such that the bottom is located eccentrically with respect to the common axis of rotation of the first link pivots 17. Hence, the supports 12, the bearing member 19 and the upper links 14 are rotatable with respect to each other about the common axis of rotation of the first link pivots 17.

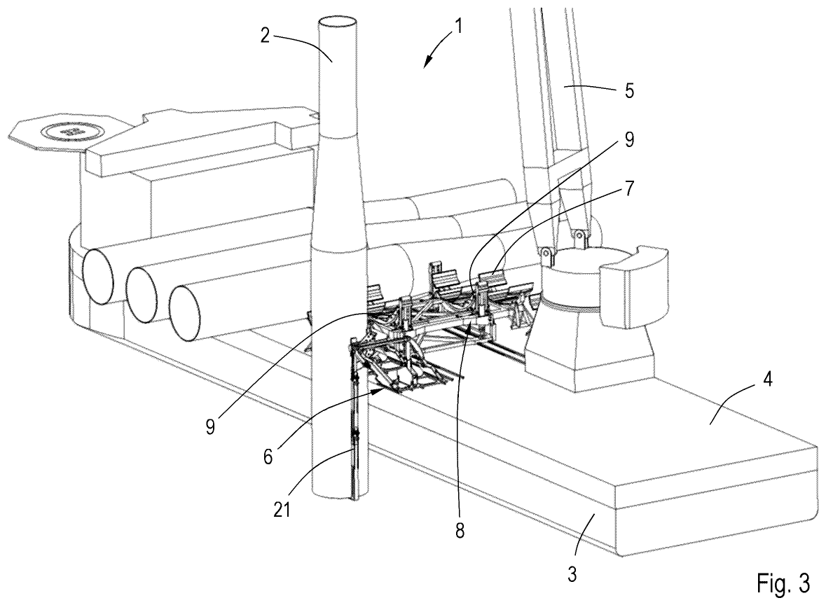

The U-shaped body 20 is provided with discrete bearing elements that together form an arc-shaped bearing surface 22 for bearing a monopile 2 in radial direction thereof, i.e. when the monopile 2 is in the horizontal position. The bearing elements may have the same shape and dimensions as the fixed cradles 7 at starboard. The supporting bracket 21 is provided with a support bar 23 for bearing a monopile 2 in axial direction thereof, i.e. when the monopile 2 is in the vertical position. The latter situation is shown in FIG. 3. The supporting bracket 21 is adjustable such that the distance between the support bar 23 and the bearing member pivots, i.e. the first link pivots 17 in this case, can be varied. This provides the opportunity to bring the support bar 23 into contact with an axial end of a monopile 2 when it is still in a horizontal position on the upending hinge 6 such that it does not slide downwardly along the supporting bracket 21 during the process of upending.

To each of the legs of the U-shaped body 20 of the bearing member 19 an annular plate section 24 is attached. The annular plate sections 24 have through-holes which are located at angular distance from each other about the common axis of rotation of the bearing member pivots. Each of the supports 12 is provided with a first releasable coupling 25 including an extendable pin which can selectively be inserted into one of the through-holes so as to mechanically couple the support 12 and the corresponding annular plate section 24.

The bearing member 19 can be rotated with respect to the supports 12 by means of adjusting rods 26 which are rotatably mounted to the respective supports 12 through rod pivots 27 which have a common axis of rotation that coincides with the common axis of rotation of the first link pivots 17. Each of the adjusting rods 26 is provided with a second releasable coupling 28 including an extendable pin which can be selectively inserted into one of the through-holes of the corresponding annular plate section 24 so as to mechanically couple the adjusting rods 26 and the corresponding annular plate sections 24 to each other. The adjusting rods 26 are rotatable with respect to the respective supports 12 by means of respective hydraulic cylinders 29 which are pivotally mounted to the respective supports 12 and adjusting rods 26. When the pins of the first couplings 25 are retracted and the pins of the second couplings 28 are inserted in one of the through-holes of the respective annular plate sections 24 the bearing member 19 will be rotated with respect to the frame 11 upon operating the hydraulic cylinders 29.

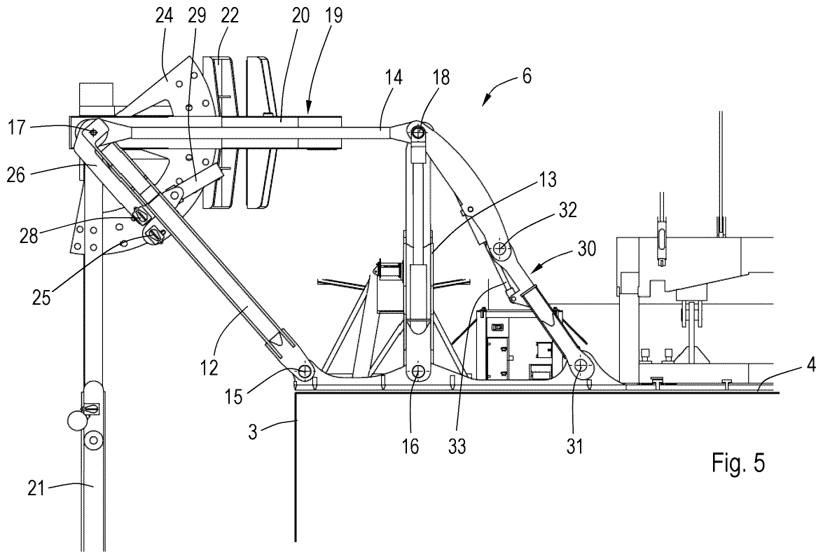

The frame 11 is further provided with parallel articulated arms 30, which are pivotally coupled to the respective four-bar linkages. Upper ends of the articulated arms 30 are mounted to the respective extendable rods 13 and the respective upper links 14 through pivots which have a common axis of rotation which coincides with the common axis of rotation of the second upper link pivots 18. Lower ends of the articulated arms 30 are mounted to the deck 4 through respective arm pivots 31 which have a common axis of rotation that is parallel to the common axis of rotation of the third bar pivots 16. FIG. 5 shows that the common axis of rotation of the third bar pivots 16 lies between the common axes of rotation of the support pivots 15 and the arm pivots 31.

Each of the articulated arms 30 has an intermediate pivot 32 which has an axis of rotation that is parallel to and lies in between the common axes of rotation of the second upper link pivot 18 and the arm pivot 31. Each of the intermediate pivots 32 divides the corresponding articulated arm 30 into two arm sections. The articulated arms 30 can be folded about the common axis of rotation of the intermediate pivots 32 by respective hydraulic cylinders 33. The hydraulic cylinders 33 are mounted to the corresponding arm sections such that when the hydraulic cylinders 33 are in extended conditions the articulated arms 30 extend substantially linearly and when they are in retracted conditions the articulated arms 30 are folded outwardly as seen from the common axis of rotation of the third bar pivot 16.

The hydraulic cylinders which cooperate with the extendable rods 13 form part of a first driving device of the upending hinge 6 and the hydraulic cylinders 33 which cooperate with the articulated arms 30 form part of a second driving device of the upending hinge 6.

FIG. 4 shows the upending hinge 6 in a monopile receiving condition in which the bearing member 19 is in a monopile receiving position. This means that the bottom of the U-shaped body 20 of the bearing member 19 is located below the common axis of rotation of the first link pivots 17 and the bearing surface 22 is facing upwardly, whereas the supporting bracket 21 extends horizontally. In this position a monopile 2 can be placed onto the bearing surface 22 between the legs of the U-shaped body 20 and the fixed monopile cradle 7 located at the upending line at starboard of the vessel 1. In that case the monopile 2 extends between the parallel four-bar linkages and the parallel articulated arms 30. It is noted that in the monopile receiving condition as shown in FIG. 4 the dimensions of the frame 11 are such that the upper links 14 extend parallel to the upper deck 4, the extendable bars 13 extend perpendicular to the upper deck 4 and the supports 12 span a plane which extends inclined with respect to the deck 4 since the common axis of rotation of the first link pivots 17 is located outside the circumferential wall 3 of the hull, but the dimensions may be different in an alternative embodiment.

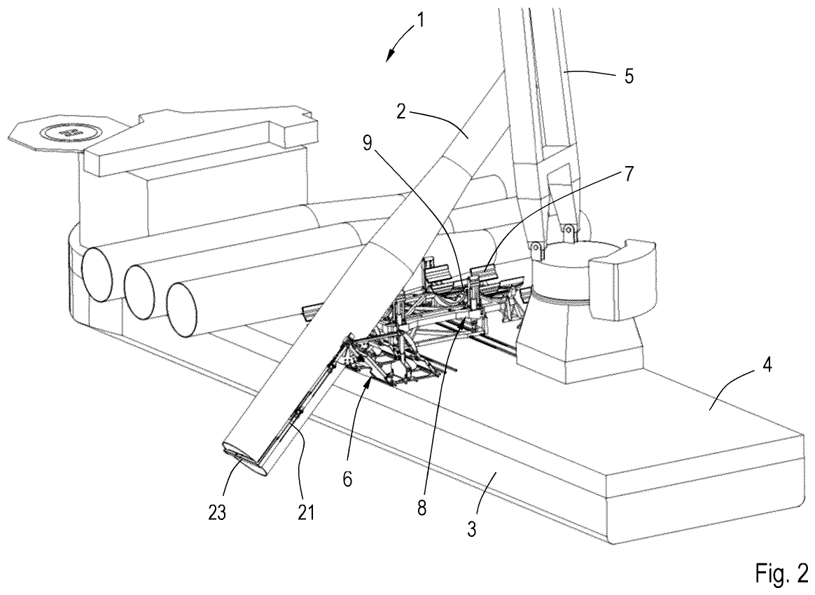

FIG. 5 shows the upending hinge 6 in a monopile upending condition in which the bearing member 19 is in a monopile upending position. This means that the bearing member 19 is rotated anti-clockwise by 90° with respect to the monopile receiving position about the common axis of rotation of the first link pivots 17. In the monopile upending position of the bearing member 19 the bearing surface 22 is located outside the circumferential wall 3 and facing away from the circumferential wall 3 at the location of the upending hinge 6. The rotation of the bearing member 19 is generated by the crane 5 which lifts the monopile 2 at an axial end thereof which is located at a distance from the support bar 23 of the support bracket 21, see FIGS. 2 and 3. During the rotation from the monopile receiving position to the monopile upending position the pins of the respective first and second couplings 25, 28 are retracted.

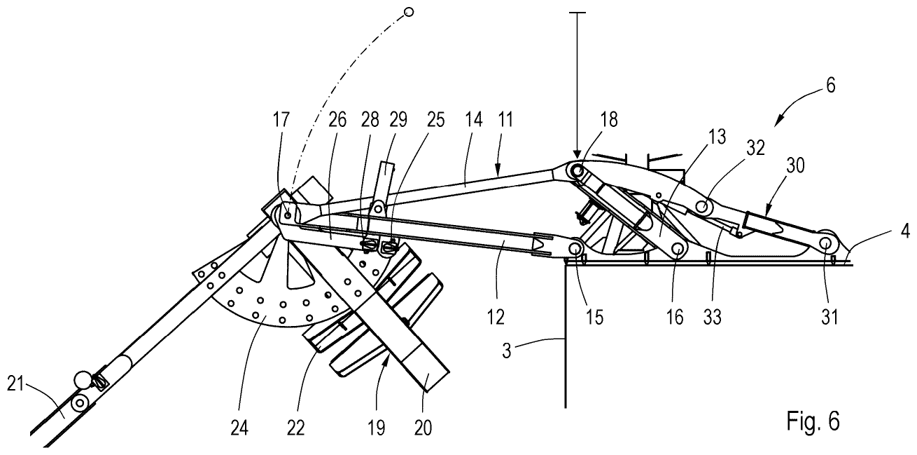

FIG. 6 shows the upending hinge 6 in a folded condition. In this condition the hydraulic cylinders which cooperate with the respective extendable rods 13 are retracted with respect to the monopile receiving condition, i.e. an unfolded condition of the upending hinge 6, as shown in FIG. 4, whereas the hydraulic cylinders 33 which cooperate with the respective articulated arms 30 remain in their extended positions. This means that the articulated arms 30 force the extendable rod 13 to rotate about the common axis of rotation of the third bar pivots 16, hence moving the upper links 14 in a direction away from the circumferential wall 3 of the hull. Consequently, the supports 12 rotate about the common axis of rotation of the support pivots 15 in the same rotational direction as the extendable rod 13. In this case the pins of the first couplings 25 are inserted in the through-holes of the corresponding annular sections 24 which through-holes are aligned to the pins of the first couplings 25 in the monopile receiving condition of the upending hinge 6, as shown in FIG. 4. This means that the relative positions of the bearing member 19 and the supports 12 remain the same during change from the monopile receiving condition, as shown in FIG. 4, to the folded condition, as shown in FIG. 6.

FIG. 6 indicates by means of a broken line a path which is followed by the first upper link pivot 17 during movement to the folded condition. FIG. 6 also illustrates by a downwardly directed arrow that the maximum height level of the upending hinge 6 above the deck 4 in the folded condition is reduced significantly with respect to the unfolded condition as shown in FIG. 4. This facilitates positioning of a monopile 2 at the upending line, since the required lifting height of the lifting carriage 8 can be minimized. It is noted that using the lifting carriage 8 instead of the crane 5 for moving a monopile 2 from a monopile storage to the upending line has several advantages such as in terms of safety.

In practice, before the lifting carriage 8 including a monopile 2 arrives at the upending line the upending hinge 6 is set in its folded condition, as shown in FIG. 6. Subsequently, the monopile 2 is moved to the upending line by the lifting carriage 8 at a slightly elevated level above the upper deck 4 until the monopile extends above the bearing surface 22 and the fixed monopile cradle 7 located at starboard of the vessel 1. Then, the upending hinge 6 is returned from the folded condition as shown in FIG. 6 to the monopile receiving condition as shown in FIG. 4, after which the lifting carriage 8 lowers the monopile 2 until it rests on the bearing surface 22 and the fixed monopile cradle 7 located at starboard of the vessel 1. The extendable rods 13 including the cooperating hydraulic cylinders, the upper links 14 and the articulated arms 30 form part of the first driving device for rotating the supports 12 about the common axis of rotation of the support pivots 15.

FIG. 6 shows that in the folded condition a large part of the upending hinge 6 is lowered to a level below the upper deck 4 outside the circumferential wall 3 of the hull. The supports 12, the upper links 14, the extendable rods 13 including the cooperating hydraulic cylinders and the articulated arms 30 as well as the support pivots 15, the first and second upper link pivots 17, 18 and the arm pivots 31 form part of a lifting mechanism for lowering the bearing member pivots with respect to their positions in the monopile receiving position of the bearing member 19.

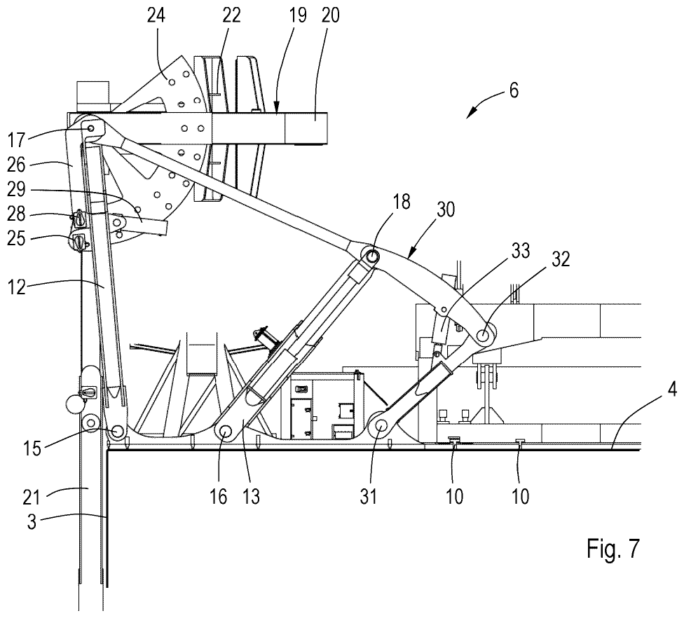

FIG. 7 shows a retracted condition of the upending hinge 6 which can be set after a monopile 2 has been upended, i.e. after the upending hinge 6 has reached the monopile upending condition as shown in FIG. 5. As described hereinbefore, in the latter situation the crane 5 has to transport the monopile 2 from the upending hinge 6 to the gripper. In order to achieve the folded condition as shown in FIG. 7 from the monopile upending condition as shown in FIG. 5 the hydraulic cylinders at the respective extendable rods 13 remain in their extended positions. The hydraulic cylinders 33 at the articulated arms 30 are retracted such that the articulated arms 30 are folded outwardly. Consequently, the extendable rods 13 and the supports 12 are forced to rotate clockwise about the common axes of rotation of the third bar pivots 16 and the support pivots 15, respectively. This means that the bearing member 19 including the supporting bracket 21 is moved in a direction which is directed from outside the circumferential wall 3 towards the circumferential wall 3 of the hull at the location of the upending hinge 6. Additionally, the hydraulic cylinders 29 which cooperate with the supports 12 and the adjusting rods 26 can be operated such that the pins of the second couplings 28 can be inserted into cooperating holes of the respective annular plate sections 24, after which the hydraulic cylinders 29 are operated such that the adjusting rods 26 are close to or contact the corresponding supports 12 and the supporting bracket 21 is close to or contacts the circumferential wall 3, as shown in FIG. 7. The pins of the first releasable couplings 25 may be retracted in this case.

FIG. 7 shows that the shape and dimensions of the frame 11 are selected such that in the retracted condition of the upending hinge 6 the supporting bracket 21 suspends along the circumferential wall 3 of the hull, whereas a largest part of the U-shaped body 20 of the bearing member 19 is positioned above the upper deck 4. As a consequence, an upended monopile 2 suspending from the crane 5 is free from the upending hinge 6 which enables the crane 5 to transport the monopile 2 towards the gripper without collisions with the upending hinge 6.

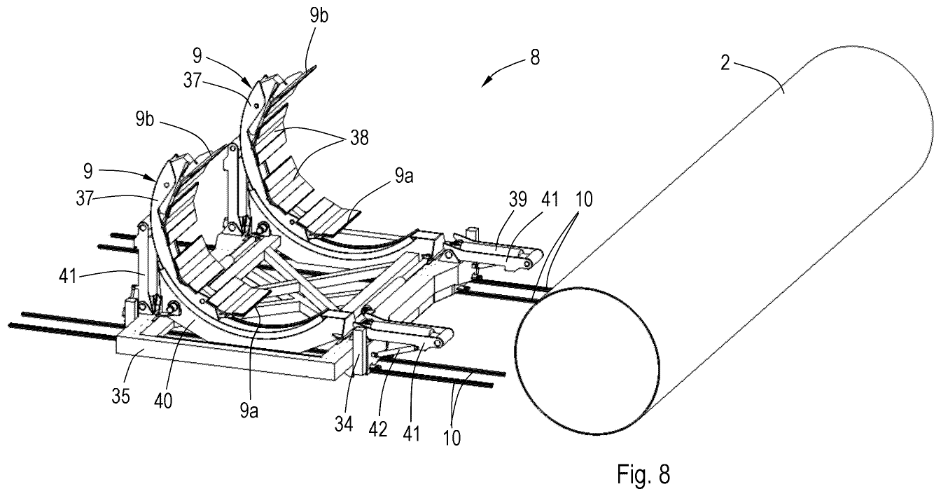

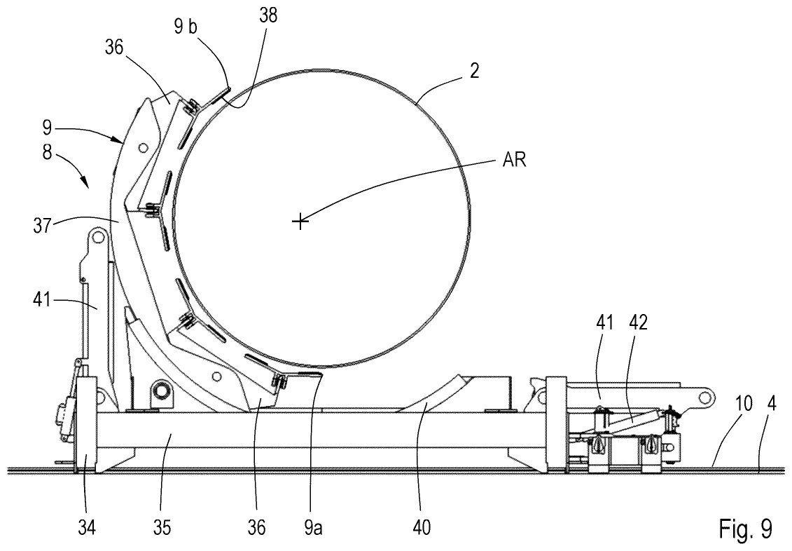

FIG. 8 shows an embodiment of a lifting carriage 8. The lifting carriage is also visible in FIGS. 1-3 and serves to lift and transport a monopile 2 from a location of the upper deck 4 where the monopiles 2 are stored to the upending line at the upending hinge 6. The lifting carriage 8 is provided with a rectangular chassis 34 which is driveable along the rails 10. The chassis 34 supports a rectangular carrier 35 which is liftable with respect to the chassis 34. The monopile cradles 9 are mounted on the carrier 35 at a distance from each other. Each of the monopile cradles 9 has an arc-shaped cradle frame 37 which is rotatable with respect to the carrier 35 about an axis of rotation AR which extends transversely to the rails 10, see FIGS. 9-11. On a concave side of the cradle frame 37 discrete support elements 38 are mounted next to each other in angular direction about the axis of rotation AR. The support elements 38 of each monopile cradle 9 provide a partly circular cylindrical supporting surface for supporting a monopile 2. The supporting surface lies on an imaginary cylinder having a substantially circular cross-section and a longitudinal centerline which substantially coincides with the axis of rotation AR. In the embodiment as shown in FIGS. 8-12 the cradle frames 37 are supported by respective arc-shaped cradle frame bearings 40 on which the cradle frames 37 can slidably move in rotational direction about the axis of rotation AR. The cradle frame bearings 40 are fixed to the carrier 35.

FIGS. 8-12 show that pairs of two support elements 38 are mounted to respective rockers 36 which in turn are mounted to the cradle frame 37 and rotatable with respect to the cradle frame 37 about an axis which is parallel to the axis of rotation AR. This configuration forces the support elements 38 to automatically take positions and orientations which appropriately fit to the circumference of the monopile 2 when the carrier 35 is lifted and the support elements 38 engage the monopile 2. This is advantageous in case that a section of the monopile 2 which is supported by the support elements 38 is not exactly a cylinder including a circular outer circumference.

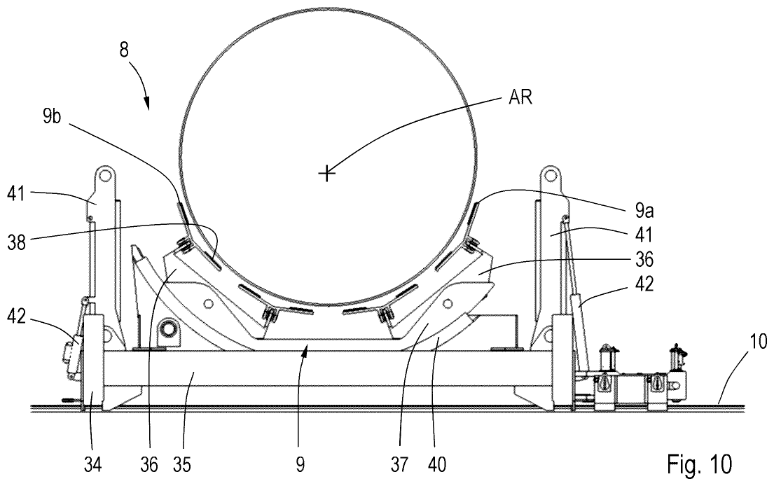

FIGS. 9-11 illustrate that each of the monopile cradles 9 extends between a first edge 9a and a second edge 9b thereof. In this case the support elements 38 form the extremities of each monopile cradle 9 including the first edge 9a and the second edge 9b, but in an alternative embodiment the cradle frame 37 may have the first edge 9a and the second edge 9b. Each of the monopile cradles 9 is rotatable with respect to the carrier 35 between a monopile supporting position, as shown in FIGS. 10-12 and a monopile approaching position as shown in FIGS. 8 and 9. In this embodiment the first edge 9a and the second edge 9b lie at substantially the same height level in case of the monopile supporting position. In the monopile approaching position the first edge 9a lies at a lower height level than in the monopile supporting position. Similarly, in the monopile approaching position the second edge 9b lies at a higher height level than in the monopile supporting position.

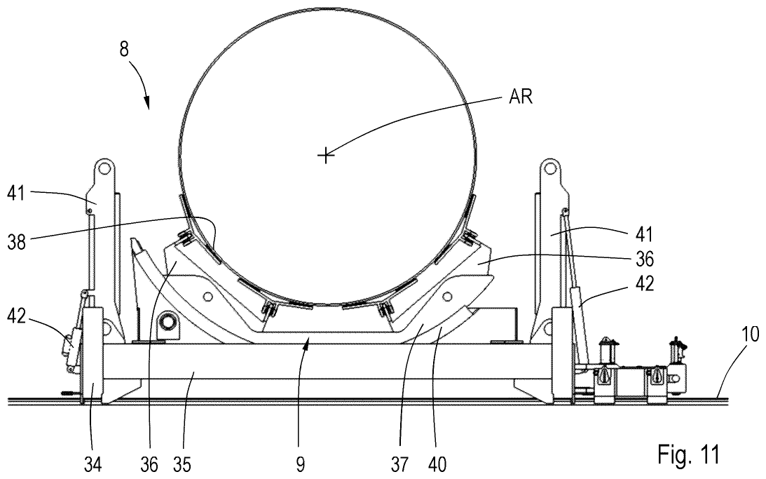

When a monopile 2 needs to be transferred from its stored location to the upending line the lifting carriage 8 can be driven towards the stored monopile 2 in its monopile approaching position as shown in FIG. 8. Just before contacting the monopile 2, as shown in FIG. 9, the monopile cradles 9 can be rotated such that they move in circumferential direction about the monopile 2 until they reach the monopile supporting position, which is illustrated in FIG. 10. Subsequently, the carrier 35 can be lifted such that the monopile 2 is engaged by the support elements 38, see FIG. 11, and then lifted from the fixed monopile cradles 7 on the deck 4 and transported to the upending line. The relatively low first edges 9a in the monopile approaching position allows the lifting carriage 8 to catch a monopile 2 which is stored on the fixed monopile cradles 7 on the upper deck 4 at a relatively low height level. A low storage level advantageously creates a stable vessel 1.

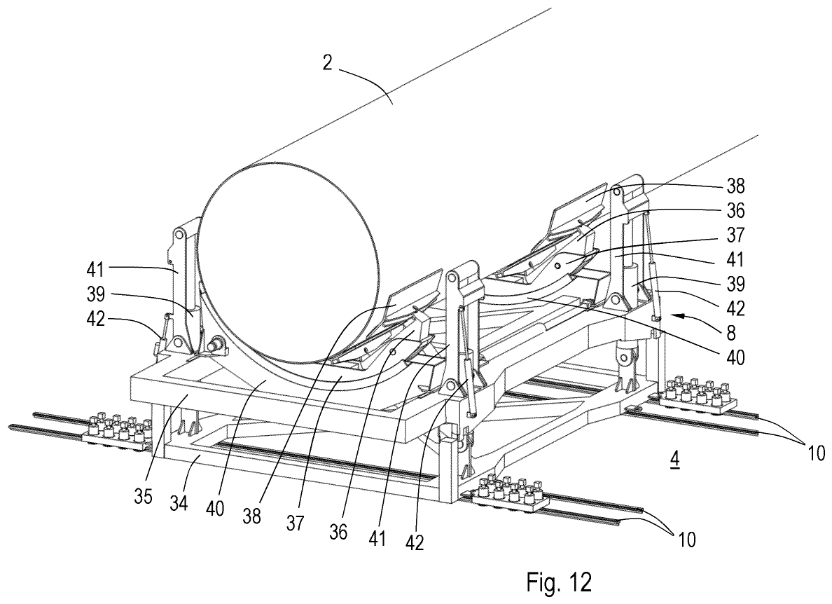

FIG. 12 illustrates a situation in which the carrier 35 is lifted with respect to the chassis 34. This is performed by means of four hydraulic cylinders 39 at respective corners of the chassis 34 and the carrier 35. The hydraulic cylinders 39 cooperate with two pairs of rods 41 at opposite sides of the carrier 35. Each pair of rods 41 is rotatable with respect to the carrier 35 about a common axis of rotation which is transverse to the rails 10. The corresponding hydraulic cylinders 39 of each pair of rods 41 are rotatably mounted to the rods 41 at a distance from the common axis of rotation and to the chassis 34. This provides sufficient space for accommodating relatively large hydraulic cylinders 39.

When the carrier 35 is in a lower position, i.e. when the hydraulic cylinders 39 are retracted, the common axis of rotation of each pair of rods 41 coincides with a common axis of rotation about which the corresponding hydraulic cylinders 39 are rotatably mounted to the chassis 34. This allows the cylinders 39 including the pair of rods 41 to rotate together between a vertical orientation and a horizontal orientation in the monopile approaching position. The latter situation is illustrated in FIGS. 8 and 9 and the former situation is illustrated in FIGS. 10-12. Hydraulic cylinders 42 are mounted to the rods 41 and the carrier 35 in order to rotate the cylinders 39 including the rods 41 between the vertical and horizontal orientations. This means that at the side of the monopile cradles 9 where their first edges 9a are located the hydraulic cylinders 39 do not obstruct the monopile cradles 9 from approaching a monopile 2 in its monopile approaching position, see FIG. 8, for example, since the hydraulic cylinders 39 are rotated away from their vertical orientations to horizontal orientations. It is clear that in this embodiment the rods 41 and the cooperating cylinders 39 provide the opportunity to catch monopiles 2 which are stored at a relatively low level. Nevertheless, alternative systems for rotating and lifting the monopile cradles 9 are conceivable.

The invention is not limited to the embodiments shown in the drawings and described hereinbefore, which may be varied in different manners within the scope of the claims and their technical equivalents.

1. A vessel comprising:
a hull including a circumferential wall, a deck and an upending hinge which is provided with a frame that is mounted to at least one of the deck and the hull at a position along the circumferential wall;
a bearing member including a bottom, two legs located at a distance from each other and extending from the bottom and a bearing surface between the legs for bearing a monopile, which bearing member is mounted to the frame through bearing member pivots at the respective legs having a common axis of rotation at a distance from the bottom of the bearing member and extending in a direction along the circumferential wall at the location of the upending hinge, wherein the bearing member has a monopile receiving position, which is a rotational position with respect to the common axis of rotation of the bearing member pivots in which the bottom of the bearing member is located below the common axis of rotation of the bearing member pivots and the bearing surface is facing upwardly, and a monopile upending position, which is a rotational position with respect to the common axis of rotation of the bearing member pivots in which the bearing surface is located outside the circumferential wall and facing away from the circumferential wall at the location of the upending hinge; and
a lifting mechanism supported by the frame, the lifting mechanism configured to lower the bearing member pivots with respect to their positions in the monopile receiving position of the bearing member.

2. The vessel according to claim 1, wherein in the monopile receiving position the common axis of rotation of the bearing member pivots lies outside the circumferential wall.

3. The vessel according to claim 1, wherein the lifting mechanism comprises a bearing member support which is mounted to the bearing member through the bearing member pivots and which is mounted to one of the deck and the hull through a support pivot having an axis of rotation which is parallel to the common axis of rotation of the bearing member pivots, wherein the bearing member support is rotatable about the axis of rotation of the support pivot by a driving device.

4. The vessel according to claim 3, wherein the bearing member support is rigid such that a distance between the common axis of rotation of the bearing member pivots and the axis of rotation of the support pivot is fixed.

5. The vessel according to claim 1, wherein the lifting mechanism comprises a four-bar linkage, of which the deck forms a first bar, whereas a second bar is mounted to the deck through a second bar pivot having an axis of rotation which is parallel to the common axis of rotation of the bearing member pivots, a third bar is mounted to the deck through a third bar pivot having an axis of rotation which is parallel to the axis of rotation of the second bar pivot and a fourth bar is formed by an upper link that is mounted to the second bar through a first upper link pivot having an axis of rotation which is parallel to the axis of rotation of the second bar pivot and to the third bar through a second upper link pivot having an axis of rotation which is parallel to the axis of rotation of the third bar pivot, wherein the bearing member is mounted to at least one of the second bar and the upper link through the bearing member pivots, wherein the second bar is rotatable about the axis of rotation of the second bar pivot by means of a driving device.

6. The vessel according to claim 5, wherein the first upper link pivot and the bearing member pivots are configured such that their axes of rotation coincide.

7. The vessel according to claim 5, wherein the third bar is extendable by an actuator such that the distance between the axes of rotation of the third bar pivot and the second upper link pivot is adjustable and wherein the lifting mechanism is provided with an arm which is mounted to at least one of the upper link and the third bar through a first arm pivot, on the one hand, and to the deck through a second arm pivot, on the other hand, which first and second arm pivots have axes of rotation which are parallel to each other and to the axis of rotation of the third bar pivot, wherein the axis of rotation of the third bar pivot lies between the axes of rotation of the second bar pivot and the second arm pivot, wherein the driving device comprises the third bar including the actuator, the upper link, the third bar pivot, the first upper link pivot, the bearing member pivots, the first arm pivot, the second upper link pivot, the arm and the second arm pivot.

8. The vessel according to claim 7, wherein the first arm pivot and the second upper link pivot are configured such that their axes of rotation coincide.

9. The vessel according to claim 7, wherein the arm is an articulated arm, comprising two arm sections which are mounted to each other through an intermediate pivot having an axis of rotation which is parallel to the axes of rotation of the first and second arm pivots, wherein the driving device is a first driving device and the frame is further provided with a second driving device configured to rotate the arm sections with respect to each other.

10. The vessel according to claim 5, wherein the lifting mechanism comprises a bearing member support which is mounted to the bearing member through the bearing member pivots and which is mounted to one of the deck and the hull through a support pivot having an axis of rotation which is parallel to the common axis of rotation of the bearing member pivots, wherein the bearing member support is rotatable about the axis of rotation of the support pivot by a driving device, and wherein the second bar of the four-bar linkage is formed by the bearing member support, the second bar pivot is formed by the support pivot, and wherein the first upper link pivot and the bearing member pivots are configured such that their axes of rotation coincide.

11. The vessel according to claim 1, wherein the vessel is provided with a lifting carriage for lifting a horizontally oriented monopile, wherein the lifting carriage comprises a chassis which is drivable in a direction of movement on the deck, an arc-shaped cradle which extends between a first edge and a second edge thereof and which is mounted to the chassis, wherein the cradle is provided with a supporting surface for supporting a horizontally oriented monopile, which supporting surface is configured to lie on an imaginary cylinder having a substantially circular cross-section and a longitudinal centerline extending transversely to the direction of movement in case of supporting a monopile, wherein the cradle is liftable with respect to the chassis and rotatable with respect to the chassis about an axis of rotation (AR) which substantially coincides with the centerline between a monopile supporting position and a monopile approaching position, wherein the first edge lies at a lower height level in case of the monopile approaching position than in case of the monopile supporting position, and wherein the second edge lies at a higher height level in case of the monopile approaching position than in case of the monopile supporting position.

12. The vessel according to claim 11, wherein the first edge and the second edge lie at substantially a same height level in case of the monopile supporting position.

13. The vessel according to claim 11, wherein an angular distance between the first edge and the second edge is smaller than 180°.

14. The vessel according to claim 11, wherein the cradle comprises a cradle frame to which discrete support elements are mounted next to each other in angular direction about the axis of rotation (AR), together providing the supporting surface, wherein the support elements are movable with respect to the cradle frame such that when the support elements engage a monopile to be lifted they will automatically take positions and orientations which fit to a circumference of the monopile.

15. The vessel according to claim 14, wherein at least two support elements are mounted to a rocker which in turn is mounted to the cradle frame and rotatable with respect to the cradle frame about an axis which is parallel to the axis of rotation (AR).
